(19) United States
(12) Patent Application Publication
(10) Pub. No.: US 2013/0071825 A1
(43) Pub. Date: Mar. 21, 2013

(54) DEMENTIA CARE SUPPORT SYSTEM

(71) Applicant: Rieko TODA, Osaka (JP)

(72) Inventor: Rieko TODA, Osaka (JP)

(73) Assignee: SHARP KABUSHIKI KAISHA, Osaka (JP)

(21) Appl. No.: 13/479,433

(22) Filed: May 24, 2012

(30) Foreign Application Priority Data
Sep. 21, 2011 (JP) 2011-205565

(51) Int. Cl. G09B 23/28

(52) U.S. Cl. 434/262

(57) ABSTRACT

Appropriate advice according to a symptom of a patient is presented to a caregiver to manage information whether or not the advice is effective so as to support the caregiver. A storage portion of a dementia care support system for outputting advice information for a caregiver about BPSD of a patient stores information of a patient as well as a caregiver, and advice information; an advice information selection portion selects any of the advice information that is stored in the storage portion based on the information of the patient and the caregiver; an information output portion outputs the advice information that is selected by the advice information selection portion; and the storage portion further stores implementation information of a content that is included in the advice information that is output from the information output portion.

### CROSS-NOTING PARAGRAPH

This non-provisional application claims priority under 35 U.S.C. §119(a) on Patent Application No. 2011-205565 filed in JAPAN on Sep. 21, 2011, the entire contents of which are hereby incorporated herein by reference.

### FIELD OF THE INVENTION

The present invention relates to a dementia care support system for outputting advice information for a caregiver about BPSD (Behavioral and Psychological Symptoms of Dementia) of a patient.

### BACKGROUND OF THE INVENTION

It is said that one out of every four people of 85 years of age or more develops dementia, which number is expected to be doubled in the next 20 years with the super-aging society just around the corner. However, dementia will never be completely healed, which significantly increases burdens on a patient and a caregiver. Therefore, it is desired that a symptom level is correctly diagnosed to take an appropriate countermeasure, thereby delaying the progress of dementia, which brings confidence and pride of a patient into recovery so that the patient and a caregiver are able to live healthily together.

Conventionally, systems have been proposed for supporting a diagnosis of a dementia level of a patient by a doctor. For example, Japanese Laid-Open Patent Publication No. 2010-259634 discloses a dementia test support system capable of obtaining a uniform test result independent of proficiency in a dementia test of a healthcare professional. Japanese Laid-Open Patent Publication No. 2007-282992 discloses a dementia diagnosis support system for supporting a doctor who diagnoses a patient who is suspected of developing dementia about whether to have a dementia symptom and how advanced the symptom is. Japanese Laid-Open Patent Publication No. 2007-048093 discloses a nursing care level judgment service system for enabling a family or the like having a person to be cared to simply judge a nursing care level.

Further, Japanese Patent No. 4174832 discloses a dementia diagnosis apparatus and a dementia diagnosis program capable of judging a level of dementia. Japanese Patent No. 3515988 discloses a system capable of controlling by a computer a sequence of work from the start of a test to outputting of a result thereof, and testing by operation by oneself without needing the presence of an examiner in a general hospital, other public facilities, and the like.

However, the above-described conventional arts are provided for performing a diagnosis and a test of dementia of a patient, and not for presenting advice for BPSD (Behavioral and Psychological Symptoms of Dementia) of a patient, nor managing information whether or not the advice is effective.

In dementia care, it is desirable not only to simply present a diagnosis result and a test result but also to present a caregiver appropriate advice for a psychological symptom such as anxiety, dysphoria, hallucination or delusion, and behavior disorder such as wandering or filthy behavior which are caused by dementia to manage information whether or not the advice is effective, however, the above-described conventional arts are not provided for performing such processing.

### SUMMARY OF THE INVENTION

An object of the present invention is to provide a dementia care support system for presenting a caregiver appropriate advice according to a symptom of a patient to manage information whether or not the advice is effective so that it is possible to support the caregiver.

An object of the present invention is to provide a dementia care support system for outputting advice information for a caregiver about BPSD (Behavioral and Psychological Symptoms of Dementia) of a patient, comprising: a storage portion for storing information of the patient and the caregiver, and the advice information; an advice information selection portion for selecting any of the advice information that is stored in the storage portion based on the information of the patient and the caregiver; and an advice information output portion for outputting the advice information that is selected by the advice information selection portion, wherein the storage portion further stores implementation information of a content that is included in the advice information that is output from the advice information output portion.

Another object of the present invention is to provide the dementia care support system, wherein the storage portion further stores information of precautions at the time of caring for the patient and information of preventive measures of the BPSD, and a prevention information selection portion is further included for selecting any of information of the precautions based on the information of the patient and the caregiver that is stored in the storage portion, and selecting any of the information of the preventive measures of the BPSD based on the implementation information of the content that is included in the advice information.

Another object of the present invention is to provide the dementia care support system, wherein the information of the patient includes information of a development history of the BPSD of the patient and information of a development status of the BPSD of the patient, the information of the caregiver includes information of a status of the caregiver, the implementation information of the content included in the advice information includes information of an effect of the advice information on the patient, information of an effect of the advice information on the caregiver, information of a status of a patient at the time of implementing the content that is included in the advice information and information of a status of a caregiver at the time of implementing the content that is included in the advice information, and the advice information selection portion selects any of the advice information stored in the storage portion based on at least one of the information of a development status of the BPSD of the patient, the information of a status of the caregiver, the information of an effect of the advice information on the patient, the information of an effect of the advice information on the caregiver, the information of a status of a patient at the time of implementing the content that is included in the advice information, and the information of a status of a caregiver at the time of implementing the content that is included in the advice information.

Another object of the present invention is to provide the dementia care support system, further comprising: a tendency judgment portion for judging a tendency of the patient based on at least one of the information of the development status of the BPSD of the patient, the information of an effect of the advice information on the patient and the information of a status of a patient at the time of implementing the content that is included in the advice information, and judging a tendency of the caregiver based on at least one of the information of a status of the caregiver, information of an effect of the advice information on the caregiver and information of a status of the caregiver at the time of implementing the content that is included in the advice information, wherein the advice information selection portion further selects any of the advice information that is stored in the storage portion based on a judgment result by the tendency judgment portion.

Another object of the present invention is to provide the dementia care support system, further comprising: a warning message output portion for outputting a warning message to the caregiver when judgment is made that the tendency of the patient is a tendency of a symptom of the patient and the tendency is a worsening tendency.

Another object of the present invention is to provide the dementia care support system, further comprising: an observation request portion for outputting information for prompting the caregiver to observe the BPSD when BPSD information of the patient is not registered in the information of the patient.

Another object of the present invention is to provide the dementia care support system, further comprising: an information update portion for receiving update of the advice information.

Another object of the present invention is to provide the dementia care support system, wherein the storage portion further stores information of a BPSD candidate as a candidate of BPSD information that is presented to the caregiver, information of a development status of the BPSD candidate, information of a countermeasure to the BPSD candidate, information of an effect of the countermeasure to the BPSD candidate and information of a status at the time of implementing the countermeasure, and a BPSD candidate countermeasure information selection portion is further included for selecting any of information of the countermeasures to the BPSD candidate that is stored in the storage portion based on at least one of the information of a development status of the BPSD candidate, the information of an effect of the countermeasure to the BPSD candidate and the information of a status at the time of implementing the countermeasure, which are stored in the storage portion.

Another object of the present invention is to provide the dementia care support system, wherein the storage portion further stores BPSD information that is presented to the caregiver and information of a development level of the BPSD candidate, and a storage information selection portion is further included for selecting information of the BPSD candidate that is stored as the BPSD information based on the information of the development level of the BPSD candidate and the information of an effect of the countermeasure to the BPSD candidate which are stored in the storage portion, and selecting the information of the countermeasure to the BPSD candidate that is stored as the advice information, then the storage portion stores the selected information of the BPSD candidate as the BPSD information, and stores the selected information of the countermeasure to the BPSD candidate as the advice information.

Another object of the present invention is to provide the dementia care support system, further comprising: an information receiving portion for receiving designation of information of the BPSD candidate that is stored as the BPSD information, and receiving designation of information of the countermeasure to the BPSD candidate that is stored as the advice information, wherein the storage portion stores the information of the BPSD candidate of which designation is received as the BPSD information, and stores the information of the countermeasure to the BPSD candidate of which designation is received as the advice information.

### BRIEF DESCRIPTION OF THE DRAWINGS

FIG. 1 is a conceptual diagram of a dementia care support system according to an embodiment of the present invention;

FIG. 2 is a conceptual diagram explaining about update of a database included in a dementia care support apparatus;

FIG. 3 is a diagram showing an example of a configuration of a terminal device according to an embodiment of the present invention;

FIG. 4 is a diagram showing an example of a configuration of the dementia care support apparatus according to an embodiment of the present invention;

FIG. 5 is a flowchart showing an example of a processing procedure of dementia care support processing according to an embodiment of the present invention;

FIG. 6 is a flowchart showing an example of a processing procedure of information output processing indicated at step S104 of FIG. 5;

FIG. 7 is a flowchart showing an example of a processing procedure of BPSD information registration request output processing indicated at step S105 of FIG. 5;

FIG. 8 is a flowchart showing an example of a processing procedure of BPSD information storage processing indicated at step S106 of FIG. 5;

FIG. 9 is a flowchart showing an example of a processing procedure of information update processing indicated at step S107 of FIG. 5;

FIG. 10 is a diagram showing an example of advice information to be output from the dementia care support apparatus;

FIG. 11 is a diagram showing an example of the advice information to be output from the dementia care support apparatus; and

FIG. 12 is a diagram showing an example of prevention information to be output from the dementia care support apparatus.

### PREFERRED EMBODIMENTS OF THE INVENTION

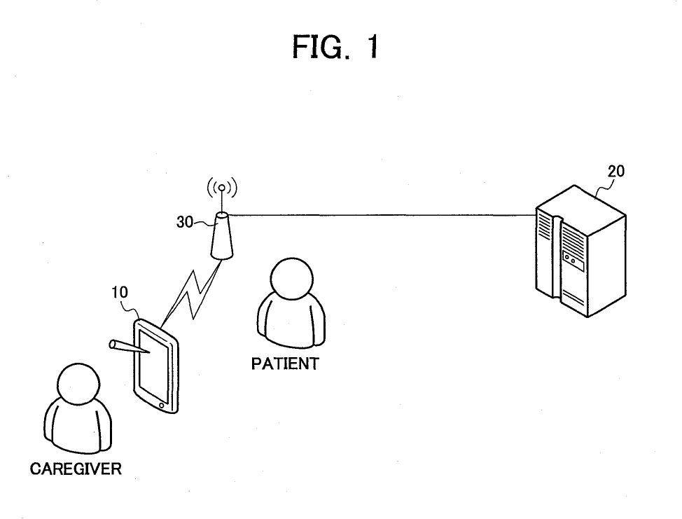

Hereinafter, description will be given in detail for embodiments of the present invention with reference to drawings. FIG. 1 is a conceptual diagram of a dementia care support system according to an embodiment of the present invention. The dementia care support system includes a terminal device 10 and a dementia care support apparatus 20 which are connected to a network through an access point 30. Note that, for the network, a wired network may be used, or a wireless network may be used.

A caregiver operates the terminal device 10 to input information of BPSD (Behavioral and Psychological Symptoms of Dementia) and affect of a patient and the like. Moreover, the caregiver operates the terminal device 10 to input information of the caregiver's own affect and reaction and the like when the patient develops a symptom of the BPSD.

Here, in a case where a plurality of factors of the BPSD are considered, information of a point for distinguishing the factors is transmitted to the terminal device 10 from the dementia care support apparatus 20 to be displayed on the terminal device 10. Then, the caregiver observes an item pointed out there, and operates the terminal device 10 to input information of an observation result.

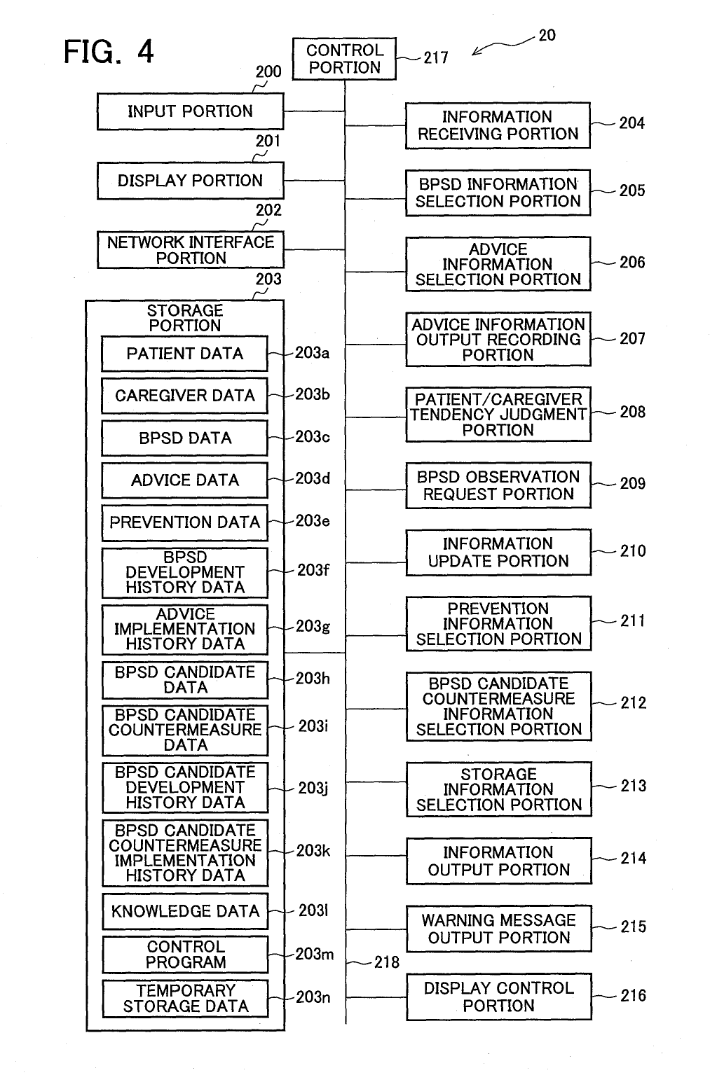

Such information input by the caregiver is transmitted to the dementia care support apparatus 20 to be registered in a database (storage portion 203 that is explained below with reference to FIG. 4) included in the dementia care support apparatus 20. Then, the dementia care support apparatus 20 outputs advice information for the caregiver and the like according to the caregiver from a BPSD symptom of the patient, statuses of the patient and the caregiver and the like.

Additionally, the dementia care support apparatus 20 outputs information of advice which has already been provided for the same symptom of a patient and has a good record. Further, the dementia care support apparatus 20 outputs, in a case where there is no effect of advice that has been provided in past times, information of advice different therefrom. Moreover, the dementia care support apparatus 20 outputs, in the case of having already provided advice to the caregiver many times, a message following up affect of the caregiver.

The caregiver views information output in this manner with the terminal device 10 to implement an advised content. Then, the caregiver operates the terminal device 10 to input information of an effect when the advised content was implemented. Moreover, the caregiver operates the terminal device 10 to input information of the patient's affect and the caregiver's own affect when the advised content is implemented. Additionally, the caregiver operates the terminal device 10 to input information of the caregiver's own feeling of accomplishment (for example, high, medium, low and the like) when the advised content is implemented.

Such information that is input by the caregiver is transmitted to the dementia care support apparatus 20 to be registered in a database. The information of an effect when the advised content is implemented is used when advice information having a good record is selected afterward. The information of the patient's affect (for example, information that the advised content was implemented by the caregiver, but had no effect, and the patient felt angry, and the like) is used when advice information different from advice information having no effect is selected afterward. The information of the caregiver's feeling of accomplishment is used when a message following up the caregiver's affect is output afterward.

Note that, various symptoms of a patient are registered in the database, however, a symptom that is not registered in the database is registered in the database as an item candidate, and when it is judged that it is appropriate to register the item candidate in the database, allowed to be registered in the database (note that, advice information is not displayed for the item candidate). This makes it possible to prevent from registering an inappropriate item in the database.

Further, a device made by a caregiver on his/her own is able to be registered in the database in association with the item candidate. Additionally, it is also possible to register in the database an item similar to an item to be registered in the database when the caregiver is advised, such as an effect that is obtained by the device.

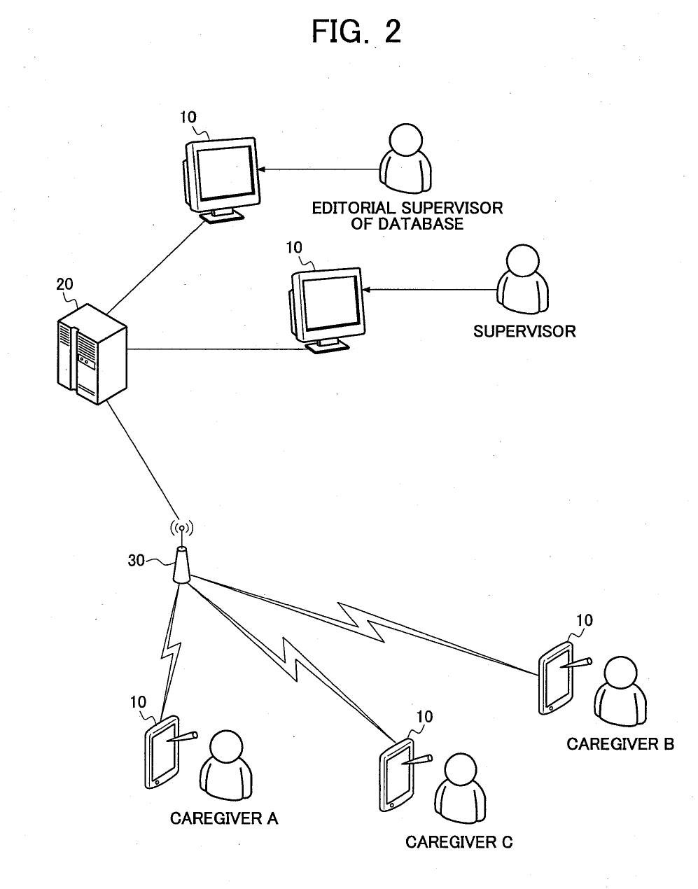

FIG. 2 is a conceptual diagram explaining about update of a database included in the dementia care support apparatus 20. The database is updated by an editorial supervisor of the database, updated by a supervisor, updated with history information that is registered by a system user or the like, in some cases.

When the database is updated by the editorial supervisor, the editorial supervisor operates the dementia care support apparatus 20 to perform update of information that is registered in the database included in the dementia care support apparatus 20. When the database is updated by the supervisor, the supervisor operates, for example, the terminal device 10 to perform update of information of a master table or the like that is registered in the database included in the dementia care support apparatus 20. Here, the supervisor is an eligible such as a doctor and a therapist.

For example, the supervisor views information of an effect of advice that is registered in the database to perform processing for deleting information of ineffective advice. Additionally, the supervisor confirms an item candidate that is registered in the database by a caregiver, and judges whether to register the item candidate as a symptom in the database, or the registration is reserved. Further, the supervisor confirms a device made for the item candidate and an effect thereof, and judges whether to register the item candidate, or the registration is reserved. When the item candidate is registered in the database as a symptom, the supervisor creates advice information for the item candidate to be registered in the database.

Note that, the supervisor is able to register in the database a symptom and a device that are registered in knowledge data. Here, the knowledge data is a database in which from a result that a caregiver as a system user implemented a device made for a symptom that is registered as an item candidate, among an item candidate that a certain development frequency or more was recognized and a device made for the item candidate, any of which having a certain ratio or more of a frequency that an effect is recognized with respect to a frequency that the device is attempted is registered.

In this case, it is possible for the supervisor to operate the dementia care support apparatus 20 to confirm a development frequency of a symptom that is registered as the item candidate for a patient as a system user, and an implementation status of a device made by a caregiver. At the time, the dementia care support apparatus 20 may display the item candidate having a greater development frequency on an upper side, or display a device having a higher effect of implementation on an upper side.

The database is automatically updated at a predetermined time interval according to a history status of a system user. In this case, the dementia care support apparatus 20 calculates and sets a perplexity level from development history information about a symptom that is registered as an item candidate. For example, the dementia care support apparatus 20 may store a point in association with each of affect, and read points corresponding to the affect from information of affect of a caregiver when a patient develops a symptom, then add those points to calculate the perplexity level.

Then, the dementia care support apparatus 20 registers in a knowledge database information of a device having a certain effect from implementation history information of a symptom with a certain rate or more of the perplexity level which is acquired relative to a value to which the perplexity levels of all symptoms are added and a device made therefor, and updates the database. This makes it possible to register in the database information with high necessity among caregivers and capable of providing effective advice.

On the other hand, a caregiver using the system operates the terminal device 10 to confirm information of an item candidate that is newly registered and a device made therefor, and confirms a caregiver's own level of perplexity for a symptom and an effect of the device to register information of a development status of a symptom of the item candidate, an implementation status of the device and the like in the database.

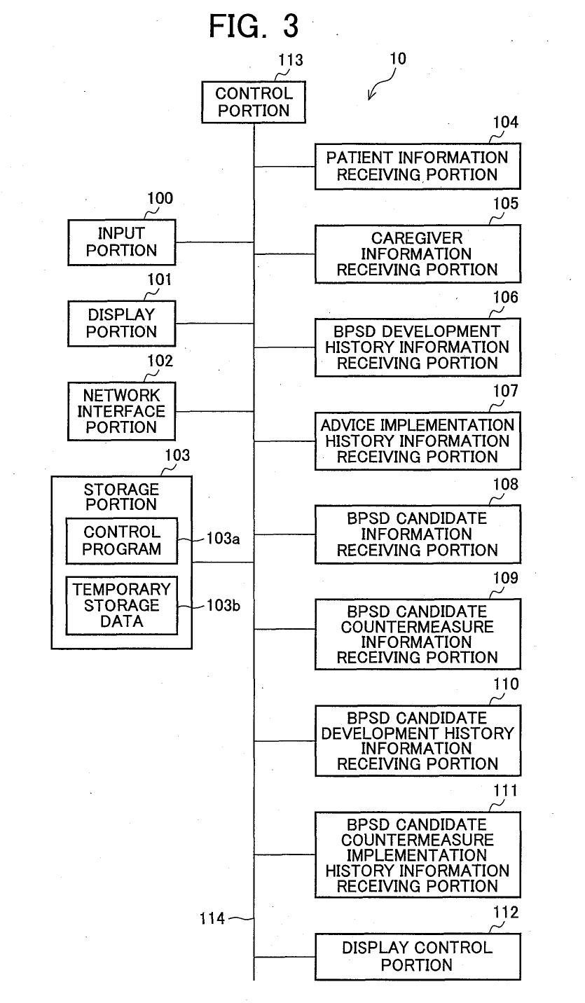

FIG. 3 is a diagram showing an example of a configuration of the terminal device 10 according to an embodiment of the present invention. The terminal device 10 is provided with an input portion 100, a display portion 101, a network interface portion 102, a storage portion 103, a patient information receiving portion 104, a caregiver information receiving portion 105, a BPSD development information receiving portion 106, an advice implementation information receiving portion 107, a BPSD candidate information receiving portion 108, a BPSD candidate countermeasure information receiving portion 109, a BPSD candidate development history information receiving portion 110, a BPSD candidate countermeasure implementation history information receiving portion 111, a display control portion 112, and a control portion 113. The function portions 100 to 113 are connected to one another via a bus 114, respectively.

The input portion 100 is an input device such as a keyboard, a mouse or a touch pad. The display portion 101 is a display device such as a liquid crystal display. The input portion 100 and the display portion 101 may be touch panels. Such a touch panel has preferably a size of 3 inches to 15 inches. The touch panel in such a size is provided for easily viewing and inputting various sorts of information, as well as being suitable also for carrying.

The network interface portion 102 is a network interface connecting to another apparatus such as the dementia care support apparatus 20 via a network.

The storage portion 103 is a storage device such as a flash ROM (Read Only Memory), an EEPROM (Electrically Erasable and Programmable ROM) or an HD (Hard Disk).

The storage portion 103 stores a control program 103a, temporary storage data 103b and the like. The control program 103a is a computer program which is read by the control portion 113 and causes the terminal device 10 to execute various processing. The temporary storage data 103b is data that is temporarily stored in the terminal device 10 such as data that is input via the input portion 100 and data that is received via a network.

The patient information receiving portion 104 is a processing portion for receiving patient information that is input by a caregiver or the like via the input portion 100 to transmit the information to the dementia care support apparatus 20 via the network interface portion 102.

The patient information includes basic information of a patient's name, age, address, family structure, living situation and the like, information of a test for a dementia diagnosis taken by a patient and a diagnosis result thereof (information of a core symptom and the BPSD, information of a score result of a test for a dementia diagnosis), information of a patient's medical history and drug history, and the like.

The test for a dementia diagnosis includes, for example, the Mini Mental State Examination (MMSE), the Japanese version of the Rivermead Behavioural Memory Test (Japanese version of the RBMT), a dementia test such as the Frontal Assessment Battery (FAB), a Magnetic Resonance Imaging (MRI) test, a Single Photon Emission Computed Tomography (SPECT) test, a blood test, an electrocardiogram examination, a chest X-ray, and the like.

The caregiver information receiving portion 105 is a processing portion for receiving caregiver information input by a caregiver or the like via the input portion 100 to transmit the information to the dementia care support apparatus 20 via the network interface portion 102. The caregiver information is information of a status (for example, a status of a caregiver when a patient develops the BPSD) as well as affect, a perplexity level for a BPSD symptom of a patient and the like of a caregiver who cares for a patient.

The BPSD development information receiving portion 106 is a processing portion for receiving BPSD development history information that is input by a caregiver or the like via the input portion 100 to transmit the information to the dementia care support apparatus 20 via the network interface portion 102. The BPSD development history information includes information on what kind of the BPSD symptom a patient developed, information of a factor that the symptom appeared, information of statuses of a patient and a caregiver at the time of developing the BPSD (including information on how a caregiver addressed), information of affect of a patient and a caregiver when the patient developed the BPSD symptom, and the like.

The advice implementation history information receiving portion 107 is a processing portion for receiving advice implementation history information that is input by a caregiver or the like via the input portion 100 to transmit the information to the dementia care support apparatus 20 via the network interface portion 102. The advice implementation history information is information of a implementation history of an advised content that is included in advice information received from the dementia care support apparatus 20, and information such as information of an effect obtained as a result of implementation of the advised content (including, for example, an effect on a caregiver in which a burden on a caregiver was reduced in addition to an effect on a patient), information of statuses of a patient and a caregiver in the case of implementing the advised content, information of affect of a patient and a caregiver at the time of implementing the advised content, and information of a caregiver's feeling of accomplishment (for example, high, medium, low and he like) at the time of implementing the advised content.

The BPSD candidate information receiving portion 108 is a processing portion for receiving BPSD candidate information that is input by a caregiver or the like via the input portion 100 to transmit the information to the dementia care support apparatus 20 via the network interface portion 102. The BPSD candidate information is information in which a BPSD symptom that is not registered in the dementia care support apparatus 20 as BPSD information is registered as the BPSD information in the case of satisfying a predetermined condition. The BPSD candidate information will be described in detail below.

The BPSD candidate countermeasure information receiving portion 109 is a processing portion for receiving BPSD candidate countermeasure information that is input by a caregiver or the like via the input portion 100 to transmit the information to the dementia care support apparatus 20 via the network interface portion 102. The BPSD candidate countermeasure information is information of a countermeasure that is devised by a caregiver for a symptom of a BPSD candidate.

The BPSD candidate development history information receiving portion 110 is a processing portion for receiving BPSD candidate development history information that is input by a caregiver or the like via the input portion 100 to transmit the information to the dementia care support apparatus 20 via the network interface portion 102. The BPSD candidate development history information includes information on what kind of a symptom of the BPSD candidate a patient developed, and information of statuses of a patient and a caregiver at the time of developing a symptom of the BPSD candidate.

The BPSD candidate countermeasure implementation history information receiving portion 111 is a processing portion for receiving BPSD candidate countermeasure implementation history information that is input by a caregiver or the like via the input portion 100 to transmit the information to the dementia care support apparatus 20 via the network interface portion 102. The BPSD candidate countermeasure implementation history information is information of an implementation history of a BPSD candidate countermeasure included in the BPSD candidate countermeasure information received from the dementia care support apparatus 20, and information such as information of an effect obtained as a result of implementation of the BPSD candidate countermeasure, information of statuses of a patient and a caregiver at the time of implementing the BPSD candidate countermeasure.

The display control portion 112 is a control portion for controlling display of information for the display portion 101. For example, the display control portion 112 controls the display portion 101 to perform processing for displaying information received from the dementia care support apparatus 20 on the display portion 101.

The control portion 113 is a control device such as a CPU (Central Processing Unit) and an MPU (Micro Processing Unit) for controlling each of the function portions 100 to 112 of the terminal device 10 while executing the control program 103a that is stored in the storage portion 103.

Note that, a printer may be connected to the terminal device 10 to print a wide variety of information that is received from the dementia care support apparatus 20.

FIG. 4 is a diagram showing an example of a configuration of the dementia care support apparatus 20 according to an embodiment of the present invention. The dementia care support apparatus 20 is provided with an input portion 200, a display portion 201, a network interface portion 202, a storage portion 203, an information receiving portion 204, a BPSD information selection portion 205, an advice information selection portion 206, an advice information output recording portion 207, a patient/caregiver tendency judgment portion 208, a BPSD observation request portion 209, an information update portion 210, a prevention information selection portion 211, a BPSD candidate countermeasure information selection portion 212, a storage information selection portion 213, an information output portion 214, a warning message output portion 215, a display control portion 216 and a control portion 217. The function portions 200 to 217 are connected to one another via a bus 218, respectively.

The input portion 200 is an input device such as a keyboard or a mouse. The display portion 201 is a display device such as a liquid crystal display. The network interface portion 202 is a network interface connecting to another device such as the terminal device 10 via a network.

The storage portion 203 stores patient data 203a, caregiver data 203b, BPSD data 203c, advice data 203d, prevention data 203e, BPSD development history data 203f, advice implementation history data 203g, BPSD candidate data 203h, BPSD candidate countermeasure data 203i, BPSD candidate development history data 203j, BPSD candidate countermeasure implementation history data 203k, knowledge data 2031, a control program 203m, temporary storage data 203n and the like.

The patient data 203a is data in which patient information received from the terminal device 10 is stored. The caregiver data 203b is data in which caregiver information received from the terminal device 10 is stored. The BPSD data 203c is data in which a BPSD symptom and information related to the BPSD symptom (for example, a development factor of a BPSD symptom and the like) are associated with each other to be stored.

The advice data 203d is data in which advice information to be presented to a caregiver is stored. The advice data 203d includes information such as advice information; information of a BPSD symptom of a patient; information of a development status of the BPSD of a patient (for example, such a symptom is frequently seen, and the like); information of a status of a caregiver when the patient developed the BPSD (for example, a caregiver was not able to care for a patient, and the like); information of an effect of advice information on a patient (for example, a symptom of a patient is improved, and the like); information of an effect of advice information on a caregiver (for example, affect of a caregiver is stabilized, and the like); information of a status of a patient at the time of implementing a content included in advice information (for example, a patient was under unaccustomed surrounding, and the like); information of a status of a caregiver at the time of implementing a content included in advice information (for example, a caregiver was able to fully care for a patient, and the like); information of a tendency of a patient (for example, a daily development frequency of a BPSD symptom of a patient tends to increase, and the like); information of a tendency of a caregiver (for example, a perplexity level of a caregiver for a development of a BPSD symptom of a patient tends to decrease, and the like); information of a caregiver to which advice information is provided; and information of a frequency of providing advice information to the caregiver, which are associated with one another to be stored. Moreover, in the advice data 203d, information of a problem that is predicted to appear in the future, information of a development frequency of a BPSD symptom of a patient, information of an effect of advice information, information of affect of a patient and a caregiver, and information of a perplexity level of a caregiver are associated with one another to be stored.

The prevention data 203e is data in which prevention information to be presented to a caregiver is stored. Here, the prevention information is information of precautions at the time of caring for a patient, preventive measures to the BPSD and the like.

In the prevention data 203e, information of precautions at the time of caring for a patient; information of a BPSD symptom of a patient; information of statuses of a patient and a caregiver at the time of developing the BPSD; information of a BPSD symptom possible to appear; information of a matter in which a patient persists; and information of a symptom that a caregiver puzzles are associated with one another to be stored. Further, in the prevention data 203e, preventive measures to the BPSD, information of effects on a patient and a caregiver obtained as a result of implementation of a content of advice, and information of statuses of a patient and a caregiver at the time of implementing a content of advice are associated with one another to be stored.

The BPSD development history data 203f is data in which BPSD development history information that is received from the terminal device 10 is stored. In the BPSD development history data 203f, information of a BPSD symptom of a patient, and information of a development status of the BPSD of a patient (for example, affect of a patient at the time of developing such a symptom, and the like) and a status of a caregiver when the patient developed the BPSD (for example, a caregiver was not able to care for a patient, and the like) are associated with one another to be stored.

The advice implementation history data 203g is data in which advice implementation history information received from the terminal device 10 is stored. In the advice implementation history data 203g, information of advice implemented; information of an effect of advice information on a patient (for example, a symptom and affect of a patient are improved, and the like); information of an effect of advice information on a caregiver (for example, affect of a caregiver is stabilized, and the like); information of a status of a patient at the time of implementing a content included in advice information (for example, a patient was under unaccustomed surrounding, and the like); and information of a status of a caregiver at the time of implementing a content included in advice information (for example, a caregiver was able to fully care for a patient, and the like) are associated with one another to be stored.

The BPSD candidate data 203h is data in which BPSD candidate information received from the terminal device 10 is stored. The BPSD candidate information means an item candidate of the symptom explained in FIG. 2. The BPSD candidate countermeasure data 203i is data in which BPSD candidate countermeasure information received from the terminal device 10 is stored. The BPSD candidate countermeasure information means the device explained in FIG. 2.

The BPSD candidate development history data 203j is data in which BPSD candidate development history information received from the terminal device 10 is stored. In the BPSD candidate development history data 203j, information of a frequency for each of a predetermined term during which a BPSD candidate appeared is further stored in association with information of the BPSD candidate. The BPSD candidate countermeasure implementation history data 203k is data in which BPSD candidate countermeasure implementation history information received from the terminal device 10 is stored.

The knowledge data 2031 is data in which information of a BPSD candidate (item candidate) and information of a BPSD candidate countermeasure (device) to the symptom are stored as described in FIG. 2. The control program 203m is a computer program that is read by the control portion 217 and causes the dementia care support apparatus 20 to execute various processing. The temporary storage data 203n is data that is temporarily stored in the dementia care support apparatus 20 such as data received via a network.

The information receiving portion 204 is a processing portion for receiving information that is input via the input portion 200 and information, that is transmitted from another device such as the terminal device 10 via a network to store the received information in the storage portion 203.

Further, the information receiving portion 204 refers to the BPSD data 203c in the case of receiving information of the BPSD symptom from the terminal device 10. Then, when there are a plurality of development factors of the BPSD symptom, the information receiving portion 204 outputs information for distinguishing the development factors to the terminal device 10 via the network interface portion 202 to obtain information of the development factors from the terminal device 10. Then, the obtained information of the development factors is stored in the BPSD development history data 203f in association with the information of the BPSD symptom.

The BPSD information selection portion 205 is a processing portion for selecting BPSD information to be presented to a caregiver from among BPSD information stored in the BPSD data 203c. For example, the BPSD information selection portion 205 reads the BPSD information corresponding to the information from the BPSD development history data 203f to select the BPSD information of the patient in the case of receiving from the terminal device 10 information for specifying a patient such as a name, an age and the like of the patient as a target of data processing.

Additionally, the BPSD information selection portion 205 selects related information of the BPSD symptom corresponding to the selected BPSD information from the BPSD data 203c. Information that is selected here is transmitted from the information output portion 214 to the terminal device 10 via the network interface portion 202.

The advice information selection portion 206 is a processing portion for selecting advice information about the BPSD of a patient to be presented to a caregiver from among advice information that is stored in the advice data 203d.

For example, the advice information selection portion 206 searches from the advice data 203d advice information corresponding to at least one piece of information of information of the BPSD symptom that is selected by the BPSD information selection portion 205; information of the BPSD symptom of a patient as well as a development status of the BPSD of the patient and information of a status of a caregiver when the patient develops the BPSD, which are stored in the BPSD development history data 203f; information of an effect of advice information on a patient, information of an effect of advice information on a caregiver, information of a status of a patient at the time of implementing a content included in advice information and information of a status of a caregiver at the time of implementing a content included in advice information, which are stored in the advice implementation history data 203g; and information of a tendency of a patient and a tendency of a caregiver which are judged by the patient/caregiver tendency judgment portion 208 that will be described below, thereby selecting the advice information.

This makes it possible to effectively provide appropriate advice to a caregiver. Further, the tendency of a patient and the tendency of a caregiver are considered so that it is possible to select more appropriate advice.

Note that, it is assumed that the advice information selection portion 206 obtains information that is specified by operation of the terminal device 10 by a caregiver to decide to search advice information corresponding to any information. Then, information that is selected by the advice information selection portion 206 is transmitted from the information output portion 214 to the terminal device 10 via the network interface portion 202.

Further, the advice information selection portion 206 refers to the advice data 203d to transmit a message following up affect of the caregiver to the terminal device 10 in addition to the selected advice information when information of a frequency of providing advice information to a caregiver is a predetermined frequency or more and information of accomplishment that is stored in the advice implementation history data 203g is “Low”.

The advice information output recording portion 207 is a processing portion for storing an achievement flag in association with advice information that has been output in past times among advice information that is stored in the advice data 203d which is registered as having an effect in the advice implementation history data 203g. When there are a plurality of advice information that are selected by the advice information selection portion 206, the advice information selection portion 206 gives priority to selection of advice information that is stored in association with such an achievement flag.

Moreover, when information of affect of a patient at the time of implementing an advised content that is stored in the advice implementation history data 203g includes a negative content such as displeasure, the advice information output recording portion 207 stores an inadequate flag in association with advice information including advice thereof. Then, when there are a plurality of advice information that are selected by the advice information selection portion 206, the advice information selection portion 206 gives priority to selection of advice information in which such an inadequate flag is not stored.

The patient/caregiver tendency judgment portion 208 is a processing portion for judging tendencies of a patient and a caregiver. For example, the patient/caregiver tendency judgment portion 208 extrapolates a time series variation of a development frequency of the BPSD symptom during a predetermined term of a patient which is stored in the BPSD development history data 203f to judge a tendency of a future development frequency of the BPSD symptom.

Additionally, the patient/caregiver tendency judgment portion 208 judges a tendency of a persistence level concerning a symptom of a patient from a development status of a symptom (information of affect and a behavioral pattern of a patient at the time of developing the BPSD symptom) that is stored in the BPSD development history data 203f. For example, the patient/caregiver tendency judgment portion 208 judges that a longer term during which a status where a patient persists in a certain matter continues leads to a higher persistence level, which is most likely to tend to be continued also in the future. Further, in a case where an interval of observation of a status where a patient persists in a certain thing becomes gradually longer, the patient/caregiver tendency judgment portion 208 judges that persistence of a patient tends to be solved.

Further, the patient/caregiver tendency judgment portion 208 extrapolates a time series variation of information of affect of a patient that is stored in the BPSD development history data 203f and the advice implementation history data 203g to judge a tendency of future affect of a patient. For example, in a case where affect of a patient changes from “instability” to “stability”, it is possible to judge a tendency of future affect of the patient as “stabilization”. Moreover, the patient/caregiver tendency judgment portion 208 extrapolates a time series variation of information of affect of a caregiver that is stored in the BPSD development history data 203f and the advice implementation history data 203g to judge a tendency of future affect of a caregiver in the same manner.

Additionally, the patient/caregiver tendency judgment portion 208 extrapolates a time series variation of information of an effect that is stored in the advice implementation history data 203g to judge a tendency of a future effect. For example, in the case of changing from “effective” to “ineffective”, it is possible to judge a tendency of a future effect as “disappearance of effects”.

Further, the patient/caregiver tendency judgment portion 208 judges a perplexity level of a caregiver. For example, the patient/caregiver tendency judgment portion 208 stores points in association with each of affect and each of behavioral patterns of a caregiver to read the points corresponding to the affect and the behavioral pattern from information of affect and behavioral patterns of a caregiver when a patient developed a symptom, and adds those points, thereby calculating the perplexity level. Additionally, the patient/caregiver tendency judgment portion 208 extrapolates a time series variation of information of the perplexity level of a caregiver with respect to a BPSD symptom of a patient to judge a tendency of a future perplexity level of the caregiver. For example, in a case where the perplexity level decreases with time, it is possible to judge the tendency of a future perplexity level of the caregiver as “dissolving”.

Moreover, the patient/caregiver tendency judgment portion 208 extrapolates a time series variation of information of the BPSD symptom of a patient that is stored in the BPSD development history data 203f to judge a tendency of a future BPSD symptom of a patient. For example, in a case where the BPSD symptom of a patient changes from “normal” to “worse”, it is possible to judge the tendency of a future BPSD symptom of a patient as “worsening”.

The BPSD observation request portion 209 is a processing portion for generating, in a case where BPSD information of a patient is not stored in the BPSD development history data 203f even when a predetermined term elapses, information for prompting a caregiver to observe the BPSD symptom of the patient and register the BPSD information of the patient. The generated information is transmitted to the terminal device 10 by the information output portion 214. This makes it possible to surely prevent input omission of information.

The information update portion 210 is a processing portion for performing update of a wide variety of information that is stored in the storage portion 203. For example, when an editorial supervisor of data such as the BPSD data 203c, the advice data 203d and the prevention data 203e that are stored in the storage portion 203 inputs update information of such data via the input portion 200, the information update portion 210 uses the update information to perform update of such data.

Further, the information update portion 210 obtains update information of data such as the BPSD data 203c, the advice data 203d and the prevention data 203e which are input by operation of the terminal device 10 by a supervisor or a system administrator, or by an editorial supervisor of a database or the like via the input portion 200, and uses the update information to perform update of such data. In this manner, a supervisor who has special knowledge of dementia modifies advice information and the like so that it is possible to increase the accuracy of advice and the like.

Note that, other information that is stored in the BPSD data 203c or the advice data 203d is input as appropriate by an editorial supervisor of a database or the like via the input portion 200, or obtained from the terminal device 10 operated by a system administrator or a supervisor to be stored in the BPSD data 203c or the advice data 203d.

The prevention information selection portion 211 is a processing portion for selecting any of information of precautions at the time of caring for a patient that is stored in the prevention data 203e, or any of information of preventive measures to the BPSD that is stored in the prevention data 203e.

For example, the prevention information selection portion 211 searches from the prevention data 203e information corresponding to at least one of information of a BPSD symptom of a patient as well as information of statuses of a patient and a caregiver at the time of developing the BPSD which are stored in the BPSD development history data 203f; information of a BPSD symptom possible to appear; information of a matter in which a patient persists; and information of a symptom that a caregiver puzzles, thereby selecting information of precautions at the time of caring for a patient.

Further, the prevention information selection portion 211 searches from the prevention data 203e information corresponding to at least one of information of an effect obtained as a result of implementation of a content of advice, and information of statuses of a patient and a caregiver when a content of advice was implemented, which are stored in the advice implementation history data 203g, thereby selecting information of preventive measures to the BPSD.

This makes it possible to effectively present a caregiver the information of precautions at the time of caring for a patient and the information of preventive measures to the BPSD that is stored in the prevention data 203e. Note that, it is assumed that the prevention information selection portion 211 obtains information that is specified by operation of the terminal device 10 by a caregiver to decide to search information of precautions and information of preventive measures corresponding to any information. Information selected here is transmitted to the terminal device 10 from the information output portion 214 via the network interface portion 202.

The BPSD candidate countermeasure information selection portion 212 is a processing portion for selecting any of information of countermeasures to BPSD candidates that are stored in the BPSD candidate countermeasure data 203i. For example, the BPSD candidate countermeasure information selection portion 212 searches from the BPSD candidate countermeasure data 203i information corresponding to at least one of information of a development status of the BPSD candidate that is stored in the BPSD candidate development history data 203j; and information of effects of a countermeasure to the BPSD candidate on a patient and a caregiver and information of statuses of a patient and a caregiver at the time of implementing the countermeasure which are stored in the BPSD candidate countermeasure implementation history data 203k, thereby selecting information of a countermeasure to the BPSD candidate.

This makes it possible to appropriately select information of a countermeasure to a BPSD candidate. Note that, it is assumed that the BPSD candidate countermeasure information selection portion 212 obtains information that is specified by operation of the terminal device 10 by a caregiver to decide to search information of a countermeasure corresponding to any information. Information selected here is transmitted to the terminal device 10 from the information output portion 214 via the network interface portion 202.

The storage information selection portion 213 is a processing portion for selecting any of information of BPSD candidates that are stored in the BPSD candidate data 203h to register the selected information in the BPSD data 203c as BPSD information, and selecting any of information of countermeasures to BPSD candidates that are stored in the BPSD candidate countermeasure data 203i to register the selected information in the advice data 203d as advice information.

For example, as described in FIG. 2, the storage information selection portion 213 refers to the BPSD development history data 203f to extract a BPSD candidate having a certain development frequency or more recognized among the BPSD candidates that are stored in the BPSD candidate data 203h. Then, the storage information selection portion 213 refers to the BPSD candidate countermeasure implementation history data 203k to extract a countermeasure having a certain rate of a frequency or more that an effect was recognized with respect to a frequency that a countermeasure was implemented among those which are stored in the BPSD candidate countermeasure data 203i as countermeasures to the extracted BPSD candidate. Then, the storage information selection portion 213 associates information of the extracted BPSD candidate with information of the extracted countermeasure to store the knowledge data 2031.

Then, when information of the BPSD candidate and information of a countermeasure to the information of the BPSD candidate that are stored in the knowledge data 2031 are specified by operation of the terminal device 10 by a supervisor, the storage information selection portion 213 stores the specified information of the BPSD candidate in the BPSD data 203c as BPSD information, as well as storing the specified information of the countermeasure in the advice data 203d as advice information.

Moreover, when a supervisor operates the terminal device 10 to select any of information of the BPSD candidate that is stored in the BPSD candidate data 203h as information to be registered in the BPSD data 203c, and also to select any of information of a countermeasure to the BPSD candidate that is stored in the BPSD candidate countermeasure data 203i as information to be registered in the advice data 203d, the storage information selection portion 213 performs the registration processing.

Thereby, it is possible to extract quality advice information and provide the extracted advice information to a caregiver. Further, a supervisor with special knowledge of dementia extracts advice information so that it is possible to enhance accuracy of advice and the like.

Note that, other information that is stored in the BPSD data 203c or the advice data 203d is input as appropriate by an editorial supervisor of a database or the like via the input portion 200, or obtained from the terminal device 10 operated by a database administrator or a supervisor to be stored in the BPSD data 203c or the advice data 203d.

The information output portion 214 is a processing portion for transmitting a wide variety of information to another device such as the terminal device 10 via the network interface portion 202. For example, the information output portion 214 transmits to the terminal device 10 information selected by the BPSD information selection portion 205, the advice information selection portion 206, the prevention information selection portion 211 and the BPSD candidate countermeasure information selection portion 212, and information generated by the BPSD observation request portion 209.

The warning message output portion 215 is a processing portion for transmitting, when the patient/caregiver tendency judgment portion 208 judges a tendency of a future symptom of a patient as “worsening”, a warning message to a caregiver to the terminal device 10 via the network interface portion 202. This makes it possible to effectively promote awareness of a caregiver.

The display control portion 216 is a control portion for controlling display of information for the display portion 201. The control portion 217 is a control device such as a CPU (Central Processing Unit) and an MPU (Micro Processing Unit) for controlling each of the function portions 200 to 216 of the dementia care support apparatus 20 and executing the control program 203m that is stored in the storage portion 203.

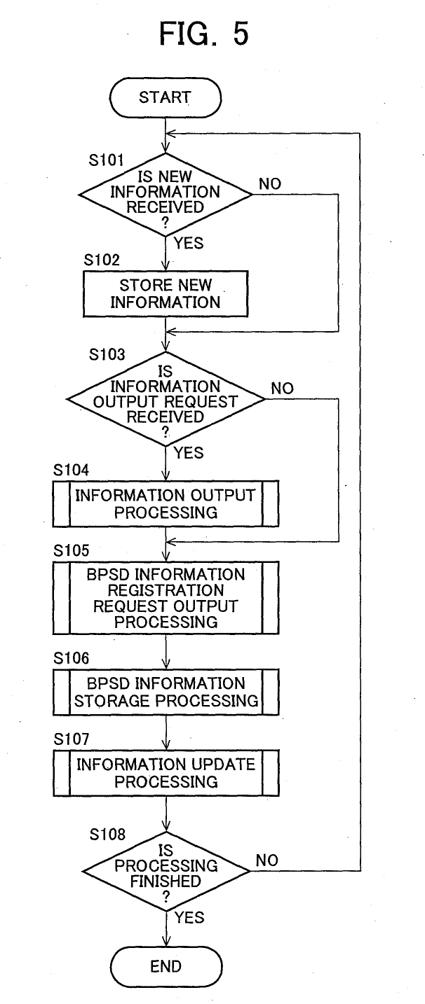

FIG. 5 is a flowchart showing an example of a processing procedure of dementia care support processing according to an embodiment of the present invention. The information receiving portion 204 of the dementia care support apparatus 20 judges whether or not new information is received from the terminal device 10 (step S101).

Here, the new information includes patient information, caregiver information, BPSD development history information, advice implementation history information, BPSD candidate information, BPSD candidate countermeasure information, BPSD candidate development history information, BPSD candidate countermeasure implementation history information and the like.

When new information is received from the terminal device 10 (in the case of YES at step S101), the information receiving portion 204 stores the received information in the storage portion 203 (step S102).

For example, the information receiving portion 204 stores patient information, caregiver information, BPSD development history information, advice implementation history information, BPSD candidate information, BPSD candidate countermeasure information, BPSD candidate development history information, BPSD candidate countermeasure implementation history information in the patient data 203a, the caregiver data 203b, the BPSD development history data 203f, the advice implementation history data 203g, the BPSD candidate data 203h, the BPSD candidate countermeasure data 203i, the BPSD candidate development history data 203j and the BPSD candidate countermeasure implementation history data 203k, respectively.

After processing at step S102, or in the case of not receiving new information (in the case of NO at step S101), the information receiving portion 204 judges whether or not an output request of information is received from the terminal device 10 (step S103). Here, the output request of information is output information of information such as advice information, preventive measure information and BPSD candidate countermeasure information.

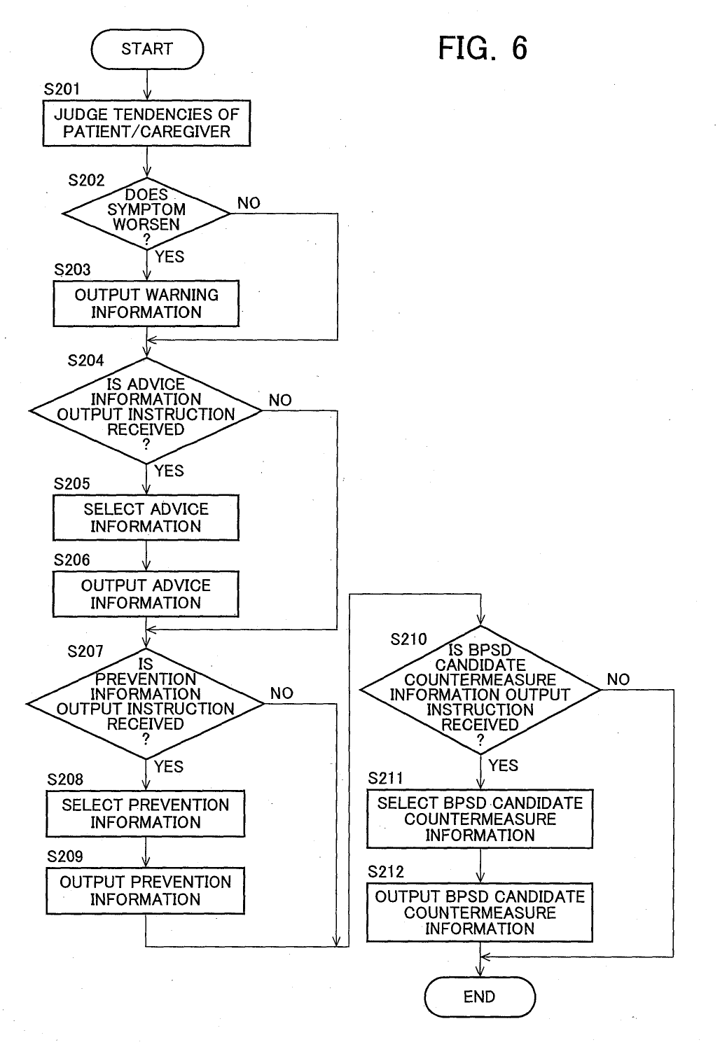

In the case of receiving the output request of information from the terminal device 10 (in the case of YES at step S103), information output processing is performed (step S104). The information output processing will be described in detail below with reference to FIG. 6.

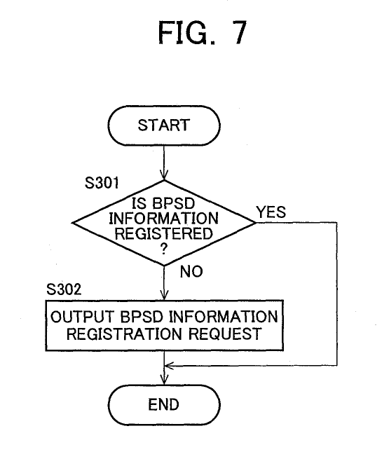

After processing at step S104, or in the case of not receiving the output request of information from the terminal device 10 (in the case of NO at step S103), BPSD information registration request output processing is performed for outputting information for prompting the caregiver to observe a BPSD symptom of a patient (step S105) in order to cause a caregiver to register BPSD information of a patient that is not registered in the BPSD development history data 203f. The BPSD information registration request output processing will be described in detail below with reference to FIG. 7.

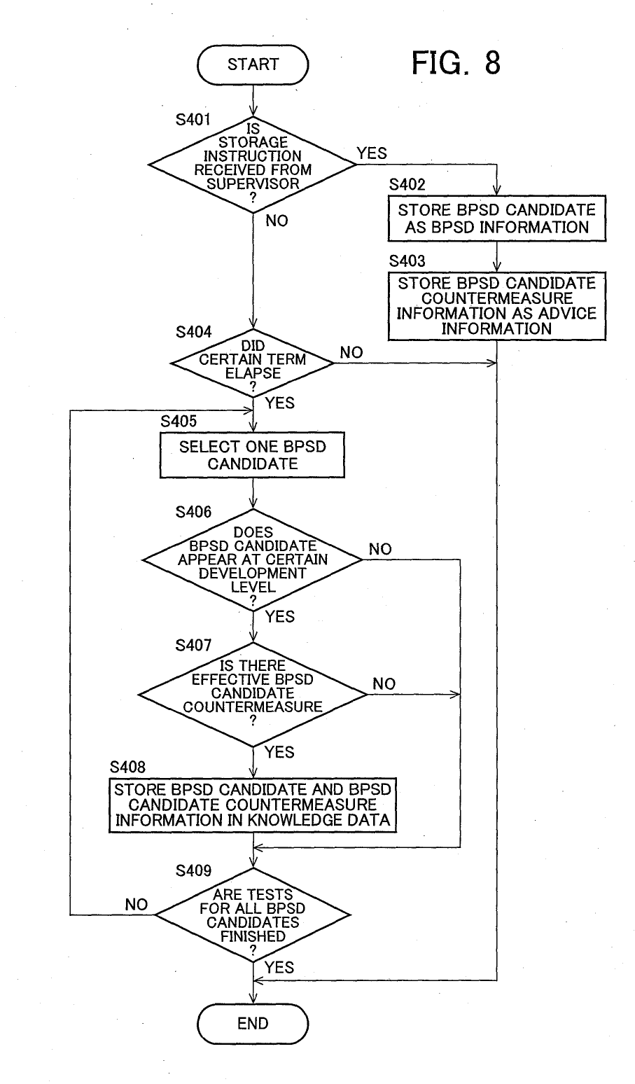

Then, BPSD information storage processing is performed for storing in the BPSD data 203c as BPSD information BPSD candidate information satisfying a predetermined condition among those which are stored in the BPSD candidate data 203h, and storing in the advice data 203d as advice information BPSD candidate countermeasure information satisfying a predetermined condition among those which are stored in the BPSD candidate countermeasure data 203i (step S106). The BPSD information storage processing will be described in detail below with reference to FIG. 8.

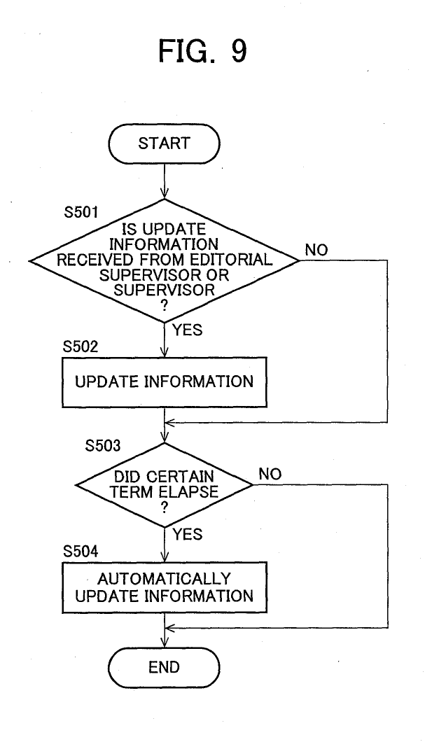

Thereafter, information update processing is performed for updating as appropriate information that is stored in the storage portion 203 (step S107). The information update processing will be described in detail below with reference to FIG. 9.

Then, the information receiving portion 204 judges whether or not information indicating that the processing is finished is received from the terminal device 10 (step S108). In the case of receiving the information indicating that the processing is finished from the terminal device 10 (in the case of YES at step S108), the dementia care support processing is finished. In the case of not receiving the information indicating that the processing is finished from the terminal device 10 (in the case of NO at step S108), the process goes to step 5101 to continue subsequent processing.

FIG. 6 is a flowchart showing an example of a processing procedure of the information output processing indicated at step S104 of FIG. 5. The patient/caregiver tendency judgment portion 208 of the dementia care support apparatus 20 judges a tendency of a future BPSD symptom of a patient based on a time series variation of information of a BPSD symptom of a patient stored in the BPSD development history data 203f (step S201).

Then, the warning message output portion 215 judges whether or not the patient/caregiver tendency judgment portion 208 judged that a BPSD symptom of a patient would get worse in the future (step S202). In the case of being judged that the BPSD symptom of a patient will get worse in the future (in the case of YES at step S202), the warning message output portion 215 transmits a warning message to a caregiver to the terminal device 10 via the network interface portion 202 (step S203).

After processing at step S203, or in the case of not being judged that the BPSD symptom of a patient will be get worse in the future (in the case of NO at step S202), the information receiving portion 204 judges whether or not an output instruction of advice information is received from the terminal device 10 (step S204).

In the case of receiving the output instruction of advice information from the terminal device 10 (in the case of YES at step S204), the advice information selection portion 206 searches from the advice data 203d advice information corresponding to at least one piece of information of information of a BPSD symptom that is selected by the BPSD information selection portion 205; information of a BPSD symptom of a patient and a development status of the BPSD of the patient that are stored in the BPSD development history data 203f; information of a status of a caregiver when the patient developed the BPSD that is stored in the caregiver data 203b; information of an effect of advice information on a patient, information of an effect of advice information on a caregiver, information of a status of a patient at the time of implementing a content included in advice information and information of a status of a caregiver at the time of implementing a content included in advice information that are stored in the advice implementation history data 203g; and information of a tendency of a patient and a tendency of a caregiver that are judged by the patient/caregiver tendency judgment portion 208, thereby selecting advice information (step S205).

Thereafter, the information output portion 214 transmits advice information that is selected by the advice information selection portion 206 to the terminal device 10 (step S206).

After processing at step S206, or in the case of not receiving the output instruction of advice information from the terminal device 10 (in the case of NO at step S204), the information receiving portion 204 judges whether or not an output instruction of prevention information was received from the terminal device 10 (step S207).

In the case of receiving the output instruction of prevention information from the terminal device 10 (in the case of YES at step S207), the prevention information selection portion 211 selects as prevention information any of information of precautions at the time of caring for a patient that is stored in the prevention data 203e, and any of information of preventive measures to the BPSD that is stored in the prevention data 203e (step S208).

Specifically, the prevention information selection portion 211 searches from the prevention data 203e, based on information of the BPSD symptom of a patient and information of a patient and a caregiver in a status where the BPSD appeared that are stored in the BPSD development history data 203f, information corresponding to such information, thereby selecting information of precautions at the time of caring a patient.

Further, the prevention information selection portion 211 searches from the prevention data 203e information corresponding to information of effects on a patient and a caregiver obtained as a result of implementation of a content of advice and information of statuses of a patient and a caregiver at the time of implementing a content of advice, that are stored in the advice implementation history data 203g, thereby selecting information of preventive measures to the BPSD.

Thereafter, the information output portion 214 transmits prevention information selected by the prevention information selection portion 211 to the terminal device 10 (step S209).

After processing at step S209, or in the case of not receiving the output instruction of prevention information from the terminal device 10 (in the case of NO at step S207), the information receiving portion 204 judges whether or not an output instruction of BPSD candidate countermeasure information is received from the terminal device 10 (step S210).

In the case of receiving the output instruction of the

BPSD candidate countermeasure information from the terminal device 10 (in the case of YES at step S210), the BPSD candidate countermeasure information selection portion 212 searches from the BPSD candidate countermeasure data 203i information corresponding to at least one of information of a development status of the BPSD candidate that is stored in the BPSD candidate development history data 203j; and information of effects of a countermeasure to the BPSD candidate on a patient and a caregiver and information of statuses of a patient and a caregiver at the time of implementing a countermeasure, which are stored in the BPSD candidate countermeasure implementation history data 203k, thereby selecting information of a countermeasure to the BPSD candidate (step S211).

Thereafter, the information output portion 214 transmits the BPSD candidate countermeasure information that is selected by the BPSD candidate countermeasure information selection portion 212 to the terminal device 10 (step S212). After processing at step S212, or in the case of not receiving the output instruction of the BPSD candidate countermeasure information from the terminal device 10 (in the case of NO at step S210), the information output processing is finished.

FIG. 7 is a flowchart showing an example of a processing procedure of BPSD information registration request output processing indicated at step S105 of FIG. 5. The BPSD observation request portion 209 of the dementia care support apparatus 20 judges whether or not BPSD information of a patient is registered in the BPSD development history data 203f (step S301).

In a case where the BPSD information of a patient is not registered in the patient data 203a even though a predetermined term elapsed (in the case of NO at step S301), the BPSD observation request portion 209 generates information for prompting a caregiver to observe a BPSD symptom of a patient and register the BPSD information of the patient, and the information output portion 214 transmits the information to the terminal device 10 (step S302).

After processing at step S302, or in a case where the BPSD information of a patient is registered in the patient data 203a (in the case of YES at step S301), the BPSD information registration request output processing is finished.

FIG. 8 is a flowchart showing an example of a processing procedure of BPSD information storage processing indicated at step S106 of FIG. 5. The storage information selection portion 213 of the dementia care support apparatus 20 judges whether or not the information receiving portion 204 receives from a supervisor an instruction to store as BPSD information in the BPSD data 203c information of the BPSD candidate that is stored in the BPSD candidate data 203h, or to store as advice information in the advice data 203d information of a countermeasure to the BPSD candidate that is stored in the BPSD candidate countermeasure data 203i or the knowledge data 2031 (step S401).

When the information receiving portion 204 receives the above-described instruction from the supervisor (in the case of YES at step S401), the storage information selection portion 213 selects information of the BPSD candidate that is specified by the supervisor, stores the information in the BPSD data 203c as BPSD information, and deletes the selected information from the BPSD candidate data 203h (step S402). Additionally, the storage information selection portion 213 selects information of a countermeasure to the BPSD candidate that is specified by the supervisor, stores the information in the advice data 203d as advice information, and deletes the selected information from the BPSD candidate countermeasure data 203i or the knowledge data 2031 (step S403). Then, the BPSD information storage processing is finished.

Note that, other information that is stored in the BPSD data 203c or the advice data 203d is input as appropriate by an editorial supervisor of a database or the like via the input portion 200, or obtained from the terminal device 10 operated by a database administrator or a supervisor to be stored in the BPSD data 203c or the advice data 203d.

In a case where the information receiving portion 204 does not receive the above-described instruction from the supervisor (in the case of NO at step S401), the storage information selection portion 213 judges whether or not a predetermined term elapsed since processing at step S405 to step S410 described below has been performed last time (step S404).

In a case where the predetermined term has not elapsed (in the case of NO at step S404), the BPSD information storage processing is finished. In a case where the predetermined term elapsed (in the case of YES at step S404), the storage information selection portion 213 selects one piece of information of the BPSD candidate that is stored in the BPSD candidate data 203h (step S405).

Then, the storage information selection portion 213 judges whether or not the selected BPSD candidate appears at a certain development level (step S406). For example, the storage information selection portion 213 refers to information that is stored in the BPSD candidate development history data 203j to judge whether or not the BPSD candidate appears at a certain frequency or more for each predetermined term.

In a case where the BPSD candidate appears at a certain development level (in the case of YES at step S406), the storage information selection portion 213 refers to information of effects that is stored in the BPSD candidate countermeasure implementation history data 203k to judges whether or not there was an effective countermeasure among information of countermeasures to the BPSD candidate that is stored in the BPSD candidate countermeasure data 203i (step S407).

In a case where there is an effective countermeasure to the above-described BPSD candidate (in the case of YES at step S407), the storage information selection portion 213 associates information of the BPSD candidate with information of an effective countermeasure to the BPSD candidate to store in the knowledge data 2031, and deletes the information of the BPSD candidate and the information of an effective countermeasure to the BPSD candidate from the BPSD candidate data 203h and the BPSD candidate countermeasure data 203i, respectively (step S408).

Note that, other information that is stored in the knowledge data 2031 is input as appropriate by an editorial supervisor of a database or the like via the input portion 200, or obtained from the terminal device 10 operated by a database administrator or a supervisor to be stored in the knowledge data 2031.

After processing at step S408, or in a case where the BPSD candidate has not appeared in the certain development level (in the case of NO at step S406), or in a case where there was no effective countermeasure to the BPSD candidate (in the case of NO at step S407), the storage information selection portion 213 judges whether or not tests after step S405 are finished for information of all BPSD candidates that is stored in the BPSD candidate data 203h (step S409).

In a case where the tests have not been finished for information of all BPSD candidates (in the case of NO at step S409), the process goes to step S405 to select one piece of information of the BPSD candidate for which the test has not been finished, and subsequent processing is executed. Ina case where the tests are finished for the information of all BPSD candidates (in the case of YES at step S409), the BPSD information storage processing is finished.

FIG. 9 is a flowchart showing an example of a processing procedure of information update processing indicated at step S107 of FIG. 5. The information update portion 210 of the dementia care support apparatus 20 judges whether or not the information receiving portion 204 received update information that is input by an editorial supervisor of a database or a supervisor (step S501).

When the information receiving portion 204 receives update information (in the case of YES at step S501), the information update portion 210 uses the update information to update information that is stored in the storage portion 203 (step S502).

After processing at step S502, or in a case where the information receiving portion 204 has not received the update information that is input by the editorial supervisor or the supervisor (in the case of NO at step S501), the information update portion 210 judges whether or not a certain term elapsed since processing at step S504 has been executed last time (step S503).

In a case where the certain term elapsed (in the case of YES at step S503), the information update portion 210 performs automatic update of the information that is stored in the storage portion 203 (step S504). For example, the information update portion 210 refers to the BPSD development history data 203f, reads from the BPSD data 203c information of the BPSD symptom that information of a development history has not been stored in the BPSD development history data 203f for a certain term or more to store in the BPSD candidate data 203h, and deletes the information of the BPSD symptom from the BPSD data 203c.

Further, the information update portion 210 reads advice information corresponding to the read information of the BPSD symptom from the advice data 203d, stores the read information in the BPSD candidate countermeasure data 203i as BPSD candidate countermeasure information, and deletes the advice information from the advice data 203d. At the same time, the information update portion 210 stores the advice information in the knowledge data 2031 in association with the read information of the BPSD symptom.

Additionally, the information update portion 210 refers to the advice implementation history data 203g, and reads from the advice data 203d advice information that an effect of the advice falls below a certain level (for example, advice information which effect is registered as “ineffective” in the case of registering three stages of “effective”, “slightly effective” and “ineffective”), stores the read information in the BPSD candidate countermeasure data 203i as the BPSD candidate countermeasure information, and deletes the information from the advice data 203d.

Moreover, when information of other advice for the BPSD symptom corresponding to the read advice information is not present in the advice data 203d, the information update portion 210 reads the BPSD symptom corresponding to the read advice information from the BPSD data 203c, stores the information in the BPSD candidate data 203h, and deletes the information from the BPSD data 203c. At the same time, the information update portion 210 stores the read information of the BPSD symptom in the knowledge data 2031 in association with the read advice information.

Additionally, the information update portion 210 receives from a supervisor designation of a BPSD symptom that is determined as an item that is required to be observed among BPSD symptoms, and performs processing for giving a flag for information of the designated BPSD symptom. Then, the information update portion 210 does not perform automatic update of information for the BPSD symptom with the flag given therefor.

Note that, other information that is stored in the BPSD data 203c or the advice data 203d is input as appropriate by an editorial supervisor of a database or the like via the input portion 200, or obtained from the terminal device 10 operated by a database administrator or a supervisor to be stored in the BPSD data 203c or the advice data 203d.

After processing at step S504, or in a case where a certain term has not elapsed (in the case of YES at step S503), the information update processing is finished.

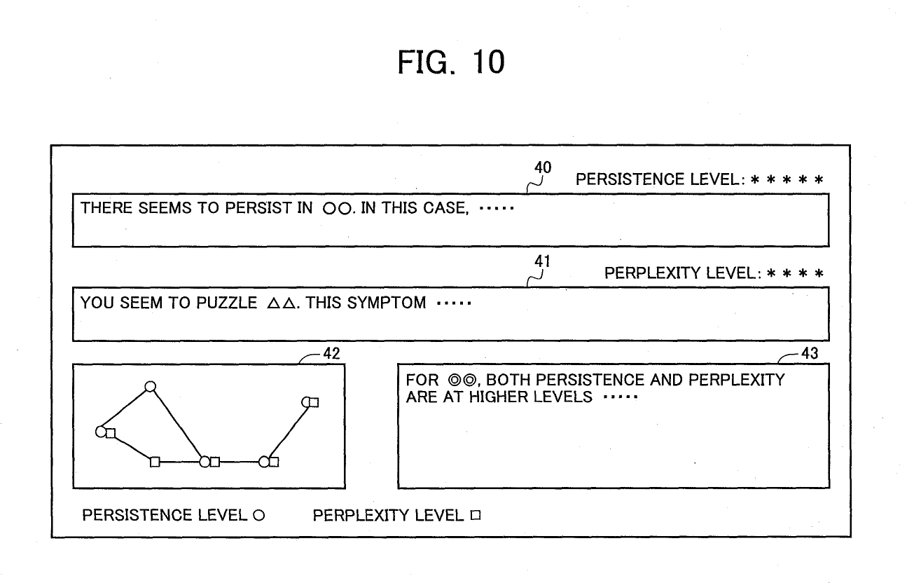

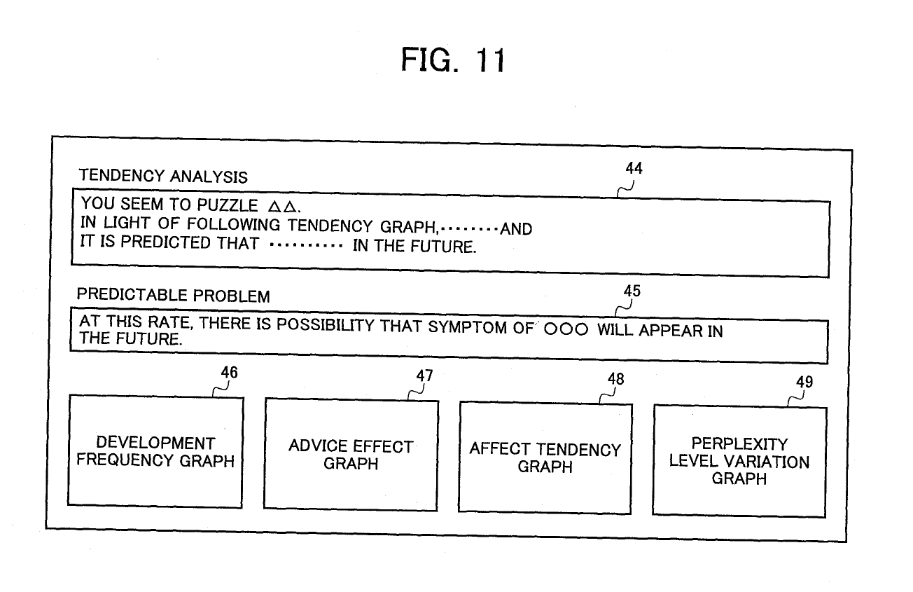

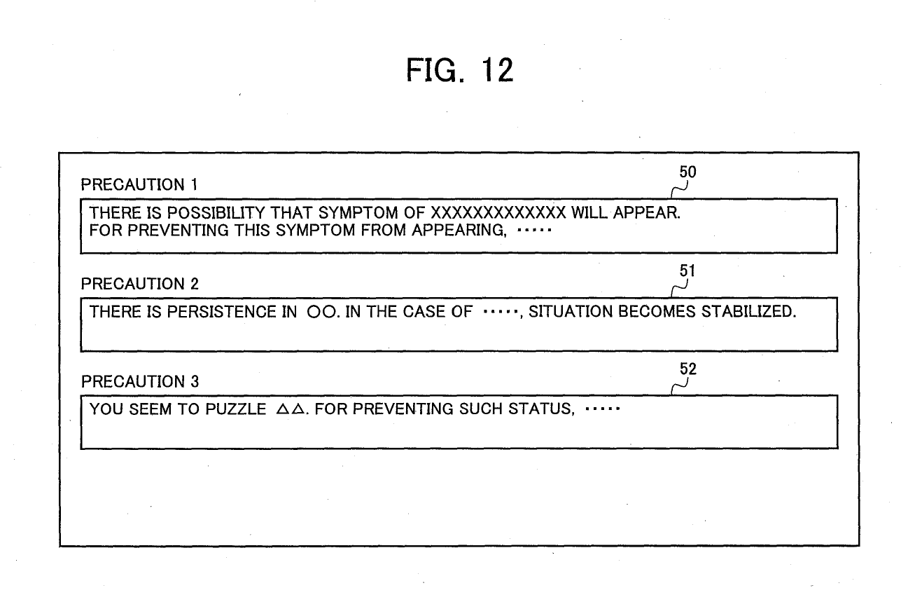

FIG. 10 and FIG. 11 are diagrams showing an example of advice information to be output from the dementia care support apparatus 20, and FIG. 12 is a diagram showing an example of prevention information to be output from the dementia care support apparatus 20. The advice information that is shown in FIG. 10 includes a great persistence level item 40, a great perplexity level item 41 and correlation information of persistence level/perplexity level 42 and 43.

The great persistence level item 40 is advice information for a patient who persists in a certain thing. Such information 40 is, for example, information that is output when a situation where a patient persists in a certain thing is registered as a status where the patient develops the BPSD. Further, such situation of persistence is judged by the patient/caregiver tendency judgment portion 208 from information of affect and a behavioral pattern of a patient at the time of developing the BPSD symptom that is registered in the BPSD development history data 203f.

The great perplexity level item 41 is advice information for a point that a caregiver puzzles. Such information 41 is, for example, information that is output when a status of greatly puzzling is registered as information of a status of a caregiver when a patient of the caregiver develops the BPSD. The status of greatly puzzling is judged by the patient/caregiver tendency judgment portion 208 from information of affect and a behavioral pattern of a caregiver at the time of developing the BPSD symptom that is registered in the BPSD development history data 203f.

The correlation information of persistence level/perplexity level 42 and 43 shows a correspondence relation between a level that a patient persists in a certain thing and a level that a caregiver puzzles accordingly, and is advice information based on the relation. Such information 42 and 43 is information that is output when a caregiver registers in the BPSD development history data 203f a status where a patient greatly persists in a certain thing as a BPSD symptom of the patient, while the caregiver registers a status where the caregiver greatly puzzles as information of a status of the caregiver when the patient develops the BPSD, and information showing a correspondence relation between a persistence level of the patient and a perplexity level of the caregiver.

Advice information that is shown in FIG. 11 includes tendency display 44 and a future problem prediction 45. The tendency display 44 is information of tendencies of a patient and a caregiver judged by the patient/caregiver tendency judgment portion 208, among which, information for an item indicating a tendency such that it needs to call attention to a caregiver (for example, information of a symptom with a promptly increased development frequency, advice information losing an effect, information of worsened affect, or the like) and an item that a caregiver particularly puzzles, in which a great perplexity level item is indicated in an example of this diagram. A development frequency graph 46, an advice effect graph 47, an affect tendency graph 48 and a perplexity level variation graph 49 are displayed with the tendency display 44.

The development frequency graph 46 is a graph showing past and future time series variations of a development frequency of a BPSD symptom of a patient. The advice effect graph 47 is a graph showing past and future time series variations of an effect that is obtained by implementing a content included in advice information. The affect tendency graph 48 is a graph showing past and future time series variations of affect of a patient and a caregiver. The perplexity level variation graph 49 is a graph showing past and future time series variations of a perplexity level of a caregiver for a BPSD symptom of a patient. Note that, future information is information that is obtained by extrapolating a past tendency by the patient/caregiver tendency judgment portion 208.

The future problem prediction 45 is information of a problem that is predicted to occur in the future. Such information is extracted from the advice data 203d by the patient/caregiver tendency judgment portion 208 based on, for example, a development frequency of a BPSD symptom of a patient, an effect of advice information, affect of a patient and a caregiver, and a perplexity level of a caregiver.

Prevention information that is shown in FIG. 12 includes an item of BPSD symptom possible to appear 50, an item of matter in which patient persists 51 and an item of symptom that caregiver puzzles 52. The item of BPSD symptom possible to appear 50 is prevention information for preventing a symptom with a high development frequency from appearing. For example, information is provided that is output when a caregiver registers a BPSD symptom of a patient in the BPSD development history data 203f at a certain frequency or more during a predetermined term. The item of matter in which patient persists 51 is prevention information that is output for a thing in which a patient persists, and the item of symptom that caregiver puzzles 52 is prevention information for preventing a status where a caregiver has a burden from occurring.

Hereinbefore, description has been given mainly for embodiments of the dementia care support system and the dementia care support method so far, however the present invention is not limited to these embodiments, and the present invention may be implemented as a form of a computer program for realizing functions of the dementia care support system, or a form of a computer-readable recording medium in which the computer program is recorded.

Here, as the recording medium, various forms are able to be employed such as a disk system (for example, magnetic disk, optical disk and the like), a card system (for example, memory card, optical card and the like), a semiconductor memory system (for example, ROM, nonvolatile memory and the like) and a tape system (magnetic tape, cassette tape and the like).

A computer program for realizing the functions of the dementia care support system, or a computer program for causing a computer to implement the dementia care support method in the above-described embodiments are recorded on these recording media to be distributed so that it is possible to improve reduction in cost, portability and versatility.

Then, the above-described recording medium is mounted on a computer and reads a computer program which is recorded in the recording medium by the computer to be stored in a memory, then a processor (CPU: Central Processing Unit, MPU: Micro Processing Unit) equipped with the computer reads from the memory and implements the computer program, so that it is possible to realize the functions of the dementia care support system according to the present embodiments and implement the dementia care support method.

Further, the present invention is not limited to the above-described embodiments, and various changes and modifications are able be made without departing from the spirit of the present invention.

As described above, according to the present invention, appropriate advice according to a symptom of a patient is presented to a caregiver to manage information whether or not the advice is effective so that it is possible to support the caregiver.

1. A dementia care support system for outputting advice information for a caregiver about BPSD (Behavioral and Psychological Symptoms of Dementia) of a patient, comprising:
a storage portion for storing information of the patient and the caregiver, and the advice information;
an advice information selection portion for selecting any of the advice information that is stored in the storage portion based on the information of the patient and the caregiver; and
an advice information output portion for outputting the advice information that is selected by the advice information selection portion, wherein
the storage portion further stores implementation information of a content that is included in the advice information that is output from the advice information output portion.

2. The dementia care support system as defined in claim 1, wherein
the storage portion further stores information of precautions at the time of caring for the patient and information of preventive measures of the BPSD, and a prevention information selection portion is further included for selecting any of information of the precautions based on the information of the patient and the caregiver that is stored in the storage portion, and selecting any of the information of the preventive measures of the BPSD based on the implementation information of the content that is included in the advice information.

3. The dementia care support system as defined in claim 1, wherein
the information of the patient includes information of a development history of the BPSD of the patient and information of a development status of the BPSD of the patient, the information of the caregiver includes information of a status of the caregiver, the implementation information of the content included in the advice information includes information of an effect of the advice information on the patient, information of an effect of the advice information on the caregiver, information of a status of a patient at the time of implementing the content that is included in the advice information and information of a status of a caregiver at the time of implementing the content that is included in the advice information, and the advice information selection portion selects any of the advice information stored in the storage portion based on at least one of the information of a development status of the BPSD of the patient, the information of a status of the caregiver, the information of an effect of the advice information on the patient, the information of an effect of the advice information on the caregiver, the information of a status of a patient at the time of implementing the content that is included in the advice information, and the information of a status of a caregiver at the time of implementing the content that is included in the advice information.

4. The dementia care support system as defined in claim 3, further comprising:
a tendency judgment portion for judging a tendency of the patient based on at least one of the information of the development status of the BPSD of the patient, the information of an effect of the advice information on the patient and the information of a status of a patient at the time of implementing the content that is included in the advice information, and judging a tendency of the caregiver based on at least one of the information of a status of the caregiver, information of an effect of the advice information on the caregiver and information of a status of the caregiver at the time of implementing the content that is included in the advice information, wherein
the advice information selection portion further selects any of the advice information that is stored in the storage portion based on a judgment result by the tendency judgment portion.

5. The dementia care support system as defined in claim 4, further comprising:
a warning message output portion for outputting a warning message to the caregiver when judgment is made that the tendency of the patient is a tendency of a symptom of the patient and the tendency is a worsening tendency.

6. The dementia care support system as defined in claim 1, further comprising:
an observation request portion for outputting information for prompting the caregiver to observe the BPSD when BPSD information of the patient is not registered in the information of the patient.

7. The dementia care support system as defined in claim 1, further comprising:
an information update portion for receiving update of the advice information.

8. The dementia care support system as defined in claim 1, wherein
the storage portion further stores information of a BPSD candidate as a candidate of BPSD information that is presented to the caregiver, information of a development status of the BPSD candidate, information of a countermeasure to the BPSD candidate, information of an effect of the countermeasure to the BPSD candidate and information of a status at the time of implementing the countermeasure, and a BPSD candidate countermeasure information selection portion is further included for selecting any of information of the countermeasures to the BPSD candidate that is stored in the storage portion based on at least one of the information of a development status of the BPSD candidate, the information of an effect of the countermeasure to the BPSD candidate and the information of a status at the time of implementing the countermeasure, which are stored in the storage portion.

9. The dementia care support system as defined in claim 8, wherein
the storage portion further stores BPSD information that is presented to the caregiver and information of a development level of the BPSD candidate, and a storage information selection portion is further included for selecting information of the BPSD candidate that is stored as the BPSD information based on the information of the development level of the BPSD candidate and the information of an effect of the countermeasure to the BPSD candidate which are stored in the storage portion, and selecting the information of the countermeasure to the BPSD candidate that is stored as the advice information, then the storage portion stores the selected information of the BPSD candidate as the BPSD information, and stores the selected information of the countermeasure to the BPSD candidate as the advice information.

10. The dementia care support system as defined in claim 8, further comprising:
an information receiving portion for receiving designation of information of the BPSD candidate that is stored as the BPSD information, and receiving designation of information of the countermeasure to the BPSD candidate that is stored as the advice information, wherein
the storage portion stores the information of the BPSD candidate of which designation is received as the BPSD information, and stores the information of the countermeasure to the BPSD candidate of which designation is received as the advice information.
